(19) United States
(12) Patent Application Publication
(10) Pub. No.: US 2007/0260905 A1
(43) Pub. Date: Nov. 8, 2007

(54) Wireless controlled wake up

(75) Inventors: Ian Marsden, Redhill (GB); Adam Leitch, Brighton (GB)

Correspondence Address: FRANCISSEN PATENT LAW, P.C., 53 W. JACKSON BLVD, SUITE # 1320, CHICAGO, IL, 60604, US

(73) Assignee: Integration Associates Inc., Mountain View, CA (US)

(21) Appl. No.: 11/414,841

(22) Filed: May 1, 2006

(51) Int. Cl. G06F 1/00

(52) U.S. Cl. 713/323

(57) ABSTRACT

A dongle 4 is attached to a USB port 8 of computer 2 through USB connector 6. The dongle in suspend mode wakes periodically, sends a polling signal, and if it receives a response the dongle enters an active mode. In embodiments, the dongle 4 uses an active scan request as the polling signal and receives a beacon frame as a response. When the dongle enters an active mode after receiving a response the dongle then wakes the computer 2 from its suspend mode. The dongle draws minimal current meeting the USB specifications.

### FIELD OF THE INVENTION

The invention relates to an electronic device for communicating between a computer and external devices, a system including such a device and a method of operating a computer and electronic transceiver, in particular to wake up the computer and transceiver from a suspend state based on wireless signals.

### BACKGROUND OF THE INVENTION

Traditionally, remote devices such as peripherals, for example keyboards and mice, have been connected to computers using wired links. However, more recently there has been an interest in connecting remote devices to a computer using wireless links.

There are a number of approaches to this, including the low power and data rate approach recorded in the IEEE 802.15.4 standard and implemented as “ZigBee”. This approach is designed to provide low cost and low power devices, which may for example be used in battery operated products with the intention that a product using the standard may run for a full year, or more, on a single alkaline battery. The ZigBee standard allows ZigBee transceivers to remain in a suspend mode for much of the time to save power.

In one implementation, a wireless transceiver sometimes referred to as a “dongle” may be attached to a USB port on a computer. A mouse and a keyboard may communicate with the wireless transceiver, for example using a Bluetooth or IEEE 802.15.4 wireless link.

A problem that occurs is that the computer may enter a suspend mode also known as a sleep mode or a standby mode. It would then be desirable to be able to wake the computer from the standby mode by moving the mouse or pressing a key on the keyboard, even when the mouse and keyboard are connected to the computer by the wireless link. However, a problem may arise in this case if the wireless transceiver is in a suspend mode, since any signal transmitted by the mouse or keyboard will not be picked up.

It might at first be thought that the solution would be to leave the wireless transceiver on when the computer is in suspend mode.

The USB standard imposes significant constraints on the current drawn by a peripheral device through a USB connector. Suspend current is a function of unit load allocation. All USB devices initially default to a low-power allocation, and such low power devices or even high-power devices operating at low-power are limited to 500 μA of suspend current. It is not possible to maintain normal operation of a wireless transceiver on this current.

While in the suspend state, a peripheral device may briefly draw more than the average current. The amplitude of the current spike cannot exceed the device power allocation 100 mA (or 500 mA). A maximum of 1.0 second is allowed for an averaging interval. The average current cannot exceed the average suspend current limit during any 1.0-second interval. The profile of the current spike is restricted so the transient response of the power supply (which may be an efficient, low-capacity, trickle power supply) is not overwhelmed. The rising edge of the current spike must be no more than 100 mA/s.

The USB standard also imposes constraints on the hub supplying the current to the devices. When a hub is in the suspend state, it must still be able to provide the maximum current per port (one unit load of current per port for bus-powered hubs and five unit loads per port for self-powered hubs). This is necessary to support remote wakeup-capable devices that will power-up while the remainder of the system is still suspended. Such devices, when enabled to do remote wakeup, must drive resume signalling upstream within 10 ms of starting to draw the higher, non-suspend current. Devices not capable of remote wakeup must draw the higher current only when not suspended.

The USB specification itself describes how remote wake up of a computer by a peripheral attached by the USB port is possible. A specific example of remote wake up of a USB hub by a USB peripheral is contained in U.S. Pat. No. 6,622,178.

When devices wakeup, either by themselves (remote wakeup) or by seeing resume signalling, they must limit the inrush current on the voltage bus on the hub. The target maximum droop in the hub voltage bus is 330 mV. The device must have sufficient on-board bypass capacitance or a controlled power-on sequence such that the current drawn from the hub does not exceed the maximum current capability of the port at any time while the device is waking up.

These specifications severely limit the current drawn by a wireless dongle attached to a hub through a USB port and used to provide wireless connectivity. If the dongle does not need to operate at all until it is woken up by the computer there is little problem. However, if the dongle is required to carry out any form of wireless operation in a suspend mode the dongle can only consume an average of 500 μA in this mode or 2.5 mA in a high power device. Current spikes are allowed provided that the spike peak current does not exceed the active current requirement of 100 mA, or 500 mA for a high power device.

This makes it very difficult to achieve wake up functionality. The challenge is to be able to switch the radio on in the dongle for sufficient time to ascertain if there is a peripheral device that is trying to communicate with it, whilst keeping the power profile drawn by the dongle through its USB port within the USB specification.

US2004/0266386 proposes a solution to this problem. A wireless USB device has a first idle mode and a second idle mode. In the second idle mode, corresponding to a suspend state, the device periodically changes to a search mode in which it listens for new transmitted data. For example, the device may be in the search mode for 80 ms every 1.2 s.

However, a problem with this approach is that it requires the remote device, for example the keyboard and/or mouse to transmit essentially continuously when actuated in order to guarantee that a signal will be present during the 80 ms out of every 1.2 s that the device is listening. The continuous transmission of a signals is not in accordance with the 802.15.4 specification. Thus, a conventional peripheral keyboard or mouse operating according to the specification would not work, and there would be a need to amend the 802.15.4 specification or use a mouse or keyboard not in accordance with that specification. This variation from the standard also makes it difficult or impossible to use conventional off-the-shelf chips implementing the standard, greatly increasing the cost of any devices using the approach.

A further problem is that it if both a mouse and a keyboard are operated and continuously send signals the transmissions from both could trample each other and result in neither being received.

Similar power transmission issues apply using other wireless protocols such as Bluetooth.

Accordingly, there remains a need for an automatic wake up system and method that is compatible with existing standards.

### BRIEF SUMMARY OF THE INVENTION

In an embodiment of a method of operating a radio communications device connected to a computer to wirelessly communicate between the computer and at least one external device, wherein the computer has a suspend mode and an active mode and the radio communications device has a suspend mode and an active mode, the method calls for entering the suspend mode in the radio communications device from an active mode with the computer in the suspend mode. The method also calls for periodically entering a polling mode in the radio communications device including transmitting a wireless signal to poll one or more external devices, waiting a predetermined period for a response signal, returning to the suspend mode if no wake-up response signal is received during the predetermined period, and if a wake-up response signal is received during the predetermined period returning the radio communications device to the active mode and communicating with the computer to cause the computer to return to the active mode.

In an embodiment of a method of operating a system including a computer with a dongle attached to the computer and at least one remote device having a wireless transceiver arranged to wirelessly communicate with the dongle, the method calls for, in the dongle, entering into a suspend mode, periodically sending a polling signal to poll one or more of the remote devices, waiting a predetermined period for a response, and returning to an active mode if a wake-up response is received in the predetermined period. This embodiment also calls for, in the at least one remote device, entering into a suspend mode in the remote device in which the transceiver in the remote device is off, receiving user input in the remote device, emerging from the suspend mode to the active mode on receiving the user input, switching on the transceiver, and waiting for a poll signal from the dongle before replying with a wake-up response to wake up the dongle.

An embodiment of a dongle for connecting to a computer for wirelessly linking the computer to one or more external devices, the dongle having an active mode and a suspend mode, the dongle includes a radio transceiver and a controller, where the controller is adapted to cause the dongle to enter the suspend mode from the active mode and in the suspend mode periodically to enter into a poll mode in which the controller sends a signal to poll one or more of the external devices, to wait a predetermined period for a response, to return to the suspend mode if there is no correct response, and to return to an active mode if a response is received.

An embodiment of a system includes a computer, a radio communications device attached to the computer and powered by the computer having an active mode and a suspend mode, and at least one remote device having a wireless transceiver arranged to wirelessly communicate with the radio communications device, at least one of the at least one remote device or devices having an active mode in which the transceiver in the remote device is on and a suspend mode in which the transceiver in the remote device is off. In the suspend mode, the radio communications device is arranged to periodically to enter into a poll mode in which the radio communications device sends a signal to poll one or more of the remote devices, to wait a predetermined period for a response, to return to the suspend mode if there is no correct response, and to return to an active mode if a response is received from one or more of the remote devices. The at least one remote device is arranged to emerge from the suspend mode to the active mode by user input and, when emerging from the suspend mode to the active mode, to switch on the wireless transceiver and to wait for a poll signal from the radio communications device before replying with a response signal.

### BRIEF DESCRIPTION OF THE DRAWINGS

Certain embodiments will now be described, purely by way of example, with reference to the accompanying drawings, in which:

FIG. 1 illustrates a system according to a first embodiment of the invention;

FIG. 2 illustrates a part of the system of FIG. 1;

FIG. 3 is a flow chart illustrating the operation of the embodiment of FIG. 1; and

FIG. 4 is a flow chart illustrating the operation of the peripheral of the embodiment of FIG. 1.

The drawings are schematic and not to scale. Like components are given like reference numerals in the different figures.

### DETAILED DESCRIPTION OF THE INVENTION

A problem that occurs is that the computer may enter a suspend mode also known as a sleep mode or a standby mode. It would then be desirable to be able to wake the computer from the standby mode by moving the mouse or pressing a key on the keyboard, even when the mouse and keyboard are connected to the computer by the wireless link. However, a problem may arise in this case if the wireless transceiver is in a suspend mode, since any signal transmitted by the mouse or keyboard will not be picked up.

It might at first be thought that the solution would be to leave the wireless transceiver on when the computer is in suspend mode.

The USB standard imposes significant constraints on the current drawn by a peripheral device through a USB connector. Suspend current is a function of unit load allocation. All USB devices initially default to a low-power allocation, and such low power devices or even high-power devices operating at low-power are limited to 500 μA of suspend current. It is not possible to maintain normal operation of a wireless transceiver on this current.

While in the suspend state, a peripheral device may briefly draw more than the average current. The amplitude of the current spike cannot exceed the device power allocation 100 mA (or 500 mA). A maximum of 1.0 second is allowed for an averaging interval. The average current cannot exceed the average suspend current limit during any 1.0-second interval. The profile of the current spike is restricted so the transient response of the power supply (which may be an efficient, low-capacity, trickle power supply) is not overwhelmed. The rising edge of the current spike must be no more than 100 mA/s.

The USB standard also imposes constraints on the hub supplying the current to the devices. When a hub is in the suspend state, it must still be able to provide the maximum current per port (one unit load of current per port for bus-powered hubs and five unit loads per port for self-powered hubs). This is necessary to support remote wakeup-capable devices that will power-up while the remainder of the system is still suspended. Such devices, when enabled to do remote wakeup, must drive resume signalling upstream within 10 ms of starting to draw the higher, non-suspend current. Devices not capable of remote wakeup must draw the higher current only when not suspended.

The USB specification itself describes how remote wake up of a computer by a peripheral attached by the USB port is possible. A specific example of remote wake up of a USB hub by a USB peripheral is contained in U.S. Pat. No. 6,622,178.

When devices wakeup, either by themselves (remote wakeup) or by seeing resume signalling, they must limit the inrush current on the voltage bus on the hub. The target maximum droop in the hub voltage bus is 330 mV. The device must have sufficient on-board bypass capacitance or a controlled power-on sequence such that the current drawn from the hub does not exceed the maximum current capability of the port at any time while the device is waking up.

These specifications severely limit the current drawn by a wireless dongle attached to a hub through a USB port and used to provide wireless connectivity. If the dongle does not need to operate at all until it is woken up by the computer there is little problem. However, if the dongle is required to carry out any form of wireless operation in a suspend mode the dongle can only consume an average of 500 μA in this mode or 2.5 mA in a high power device. Current spikes are allowed provided that the spike peak current does not exceed the active current requirement of 100 mA, or 500 mA for a high power device.

This makes it very difficult to achieve wake up functionality. The challenge is to be able to switch the radio on in the dongle for sufficient time to ascertain if there is a peripheral device that is trying to communicate with it, whilst keeping the power profile drawn by the dongle through its USB port within the USB specification.

US2004/0266386 proposes a solution to this problem. A wireless USB device has a first idle mode and a second idle mode. In the second idle mode, corresponding to a suspend state, the device periodically changes to a search mode in which it listens for new transmitted data. For example, the device may be in the search mode for 80 ms every 1.2 s.

However, a problem with this approach is that it requires the remote device, for example the keyboard and/or mouse to transmit essentially continuously when actuated in order to guarantee that a signal will be present during the 80 ms out of every 1.2 s that the device is listening. The continuous transmission of a signals is not in accordance with the 802.15.4 specification. Thus, a conventional peripheral keyboard or mouse operating according to the specification would not work, and there would be a need to amend the 802.15.4 specification or use a mouse or keyboard not in accordance with that specification. This variation from the standard also makes it difficult or impossible to use conventional off-the-shelf chips implementing the standard, greatly increasing the cost of any devices using the approach.

A further problem is that it if both a mouse and a keyboard are operated and continuously send signals the transmissions from both could trample each other and result in neither being received.

Similar power transmission issues apply using other wireless protocols such as Bluetooth.

Accordingly, there remains a need for an automatic wake up system and method that is compatible with existing standards.

According to an aspect of the invention, there is provided a method of operating a computer and electronic transceiver to communicate between the computer and external devices, the method comprising entering a suspend mode from an active mode and in the suspend mode periodically sending a wireless signal to poll one or more of the external devices, waiting a predetermined period for a response, returning to the suspend mode if there is no correct response, and returning to the active mode if a response is received.

Unlike the approach of US2004/0266386, by sending a polling signal out periodically the remote devices merely need to respond to the signal. Thus, remote devices operate in accordance with conventional standards and conventional remote devices and in particular remote devices using standard communications chipsets may be used.

Note that in this context the term “polling” is intended to refer to a communications technique in which a polling signal is sent out to the external devices and the external devices respond to that signal, instead of a communications technique where the external devices transmit continuously or intermittently without needing to receive a signal. Such polling techniques may include techniques referred to in communications standards using different and/or more specific nomenclature, for example techniques including data request or active scan signals as the beacon signals.

No response will be received from remote devices that have not been activated, since such remote devices will be in standby mode and accordingly their receiver will be switched off.

A particularly preferred implementation connects the computer to the electronic transceiver through a USB port and powers the electronic transceiver through the USB port.

In another aspect, the invention relates to a dongle for connecting to a computer for wirelessly linking the computer to one or more external devices, the dongle having an active mode and a suspend mode, and including a radio transceiver and a controller. The controller is adapted to cause the dongle to enter the suspend mode from the active mode and in the suspend mode periodically to enter into a poll mode in which the controller sends a signal to poll one or more of the external devices, to wait a predetermined period for a response, to return to the suspend mode if there is no correct response, and to return to an active mode if a response is received.

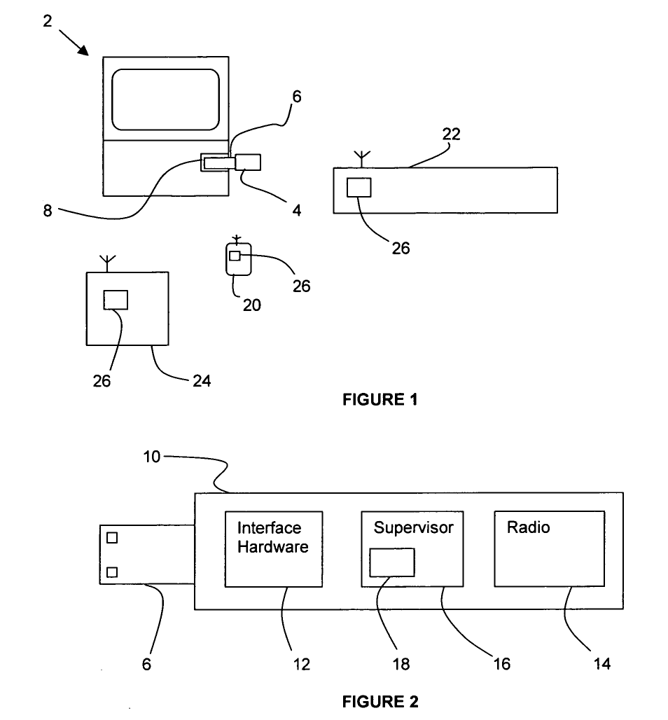

Referring to FIGS. 1 and 2, in a specific embodiment of the invention, a computer 2 acts as a hub and a supply of power. A dongle 4 with a USB connector 6 is connected into USB port 8 of the computer 2. In a particularly preferred embodiment, the dongle is contained within a small housing 10 directly supported by the connections between USB connector and USB port, but in an alternative embodiment the dongle may be a separate housing connected to the USB port by wire.

The computer is shown schematically—the computer may be a desktop or laptop model or indeed another component with a port 8 and some computing capability.

The dongle 4 has three main components, a USB Interface hardware 12, an 802.15.4 radio 14; and a suspend mode supervisor 16 with an internal RC oscillator 18. These may be implemented as separate chips or any two or all three of them may be implemented as a single chip solution.

The suspend mode supervisor 16 is in the embodiment described a very low power microcontroller. In the suspend mode, this suspend mode supervisor is the only active device on the dongle. The radio 14 is asleep (in suspend mode with the power supply switched off) and the USB interface 12 halted. Running from internal RC oscillator 18 this supervisor 16 is arranged to periodically wakeup the radio 14 to check for messages and ascertain if the USB device needs waking up. If however no host wakeup is required then the supervisor 16 would put the radio back into sleep mode and await the next communication cycle.

The system may include one or more remote devices, including a mouse 20 and a keyboard 22. Other remote devices such as a printer 24 may also be included. Note that it is unlikely that it will be required that operation of the printer wakes up the dongle 4 and the computer 2, so the dongle only needs to wake up when one of a limited number of predetermined remote devices wakes up. These remote devices will be referred to as the “wake-up remote devices” in this patent specification. The wake up remote devices include a transceiver 26.

In other embodiments, further wake-up remote devices may be included such as a remote control device (not shown).

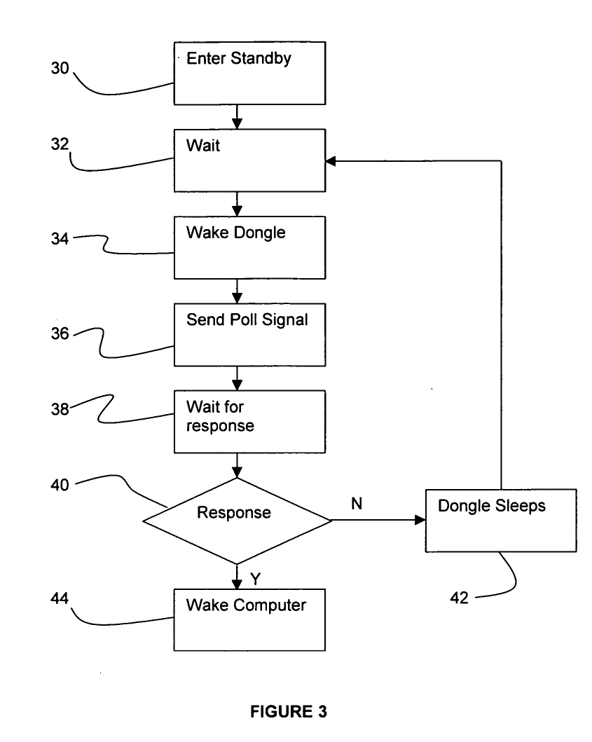

FIG. 3 is a flow chart that illustrates the operation of the dongle 4 and computer 2 in use.

The flow chart starts in step 30 with both the computer 2 and dongle 4 entering a suspend mode. The computer 2 and dongle then wait in the suspend mode for a predetermined period (step 32).

In step 34, the dongle wakes up into a polling mode and powers up its radio 14. The USB interface can remain switched off. In step 36 the radio 14 is used to send a polling signal.

In step 38 the dongle waits for a predetermined duration. It determines if a response is received from one of the wake-up remote devices 20, 22 in step 40 and if not the dongle goes back to its suspend mode in step 42, powering down its radio 14 and returning to step 32 and waking up again after a further predetermined period. Thus, the dongle cycles through the loop of steps 32 to 42 until an active device wakes it.

If a response is received from one of the wake-up remote devices 20, 22, the dongle 4 instead powers up its interface 12, and wakes up the computer 2 by passing a signal to wake up the computer through the USB port 6 (step 44).

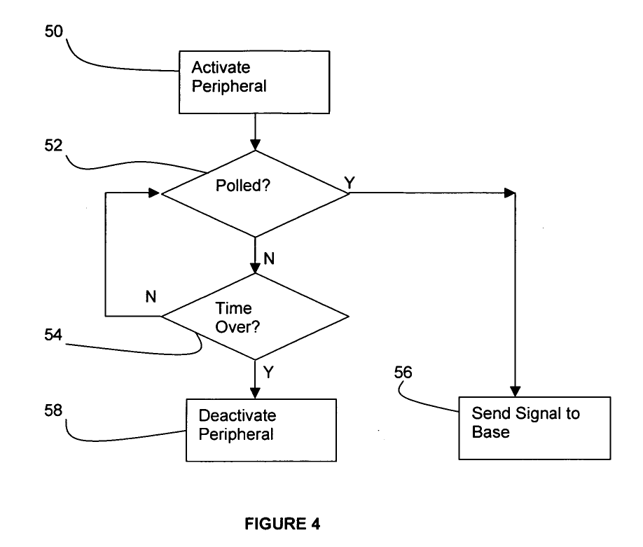

FIG. 4 is a flow chart illustrating the operation of the wake-up remote devices 20, 22.

The wake-up remote devices 20, 22 are arranged to remain in suspend mode until they are activated by the user. For a mouse, this may be done by moving the mouse, and for the keyboard this may be done by pressing one or more keys. Thus, in step 50 the wake-up remote device is activated.

To avoid the need for the wake up remote devices to continuously transmit when they wake up, the wake-up remote device then waits (step 52) to be polled by the dongle 4 before communicating.

If a polling signal is received, the wake-up remote device then transmits a signal (step 56) back to the dongle 4 to instruct the dongle 4 to wake up. This is received by the dongle 4 which then switches on the computer 2 (step 44, FIG. 3).

The wake-up remote device continues to wait for a polling signal for a predetermined time, but if no signal is received after that time (step 54), the wake-up remote device returns to suspend mode (step 58) to avoid draining the battery of the wake-up remote device 20, 22 in the case that there is no active dongle within range.

There are a number of possibilities for the signal sent. In a first embodiment, the remote device 20, 22 waits (step 52) for a beacon request sent (step 34) from the dongle 4.

This method is allowed by the IEEE 802.15.4 specification. The dongle periodically wakes up and performs an active scan which causes a beacon request command frame to be issued as a polling signal (step 36) with scan duration set to 0 (15 ms). In the embodiment, the scan duration is minimised in this way to save power and to allow a more frequent poll interval. Thus, in this case the predetermined period in step 38 is 15 ms. The remote device 20, 22 is configured to respond (step 56) to beacon request command frames with a beacon frame. This response only occurs when the remote device 20, 22 is attempting to wake the dongle since at all other times its receiver would not be on.

Note that although this functionality is permitted by the standard the functionality is very different to the conventional use of active scans and beacons. The IEEE 802.15.4 standard conventionally uses beacon frames to identify the more capable device to a new or lesser capable device for example to allow the synchronisations of a number of devices. Thus conventionally a peripheral would transmit a beacon request and the hub responds. In the present embodiment, it is the dongle 4, i.e. the hub, that transmits the beacon request and the peripheral that responds with a beacon frame.

The effect of this is that the dongle 4 will receive a beacon frame from each remote device 20, 22 attempting to wake it. If multiple remote devices 20, 22 wanted to wake the dongle, multiple beacon frames would be received during the scan period since these beacons would be sent using CSMA.

Below follows a table showing the stages of the periodic active scan. It also details the current consumed in each stage along with the time spent in each stage.

In this first embodiment, the time the dongle 4 is out of its sleep mode is just less than 30 ms, including 15 ms waiting to receive in step 36 and the rest, approximately another 15 ms, being the time to turn the transmitter on in the transceiver 14, to prepare and transmit the beacon command frame in step 34, to receive any responses and to switch back off again. The total current integrated over time is approximately 2 milliamp second of energy in a wake-up period of approximately 30 ms.

In standby, the system draws a standby current of 0.4 mA, including for example 100 μA from linear regulators, 3 μA from the transceiver 14 in sleep mode 3 μA, and in particular 300 μA drawn by the supervisor 16.

In a high power device, to calculate the minimum duty cycle, the following formula is used:
A*X=B(X−C)+(C*D)

where

A=High power device average current allowed by the USB specification (2.5 mA)

B=Dongle idle current (0.4 mA)

C=The duration of the active period (30 ms)

D=The average current during the active period (70 mA) and

X is the seconds between active scans (The duty cycle)

Therefore, the maximum achievable duty cycle when the first embodiment is used as a high power USB device is approx 1 second.

The first embodiment can also be used as a low power USB device with a less frequent duty cycle of about 20 seconds.

Thus, it is technically feasible to implement a remote wakeup facility following an event on the 802.15.4 network. If the device was configured as a high power USB device then such a wakeup could be triggered within a second of the event occurring (for example the user pressing a button on a remote control), which is an acceptable length of time for this type of device.

This wake-up time could be improved further by further optimisations of the component power consumption within the dongle device.

In a second embodiment, a similar approach is used in that if the remote device 20, 22 wishes to wake up the dongle 4 it enables its receiver in transceiver 26 (step 52). In the second embodiment however the dongle 4 emits an 802.15.4 data request specific to the remote device 20, 22 and the remote device 20, 22 receives and acknowledges if and only if the remote device has its transceiver 26 switched on. As before, this only occurs when the remote device wants the computer 2 to wake up.

This method is allowed by the IEEE 802.15.4 specification. Note if there are multiple wake-up remote devices then they would all need separate polling, which would in turn increase the active time, and further if the wake-up remote device is not activated the dongle 4 is forced to perform MAC retries, which increases the active time.

The multiple polling makes the second embodiment more reliable in that if packet loss is experienced the extra polling makes it more likely that a message is received. The exact number of retries is dictated by a variable in the 802.1.5.4 specification (aMaxFrameRetries) which defaults to 3, so each message is sent once and repeated three further times. If a different choice is required, this variable can be changed to suit.

The second embodiment includes a further refinement. The data request is sent to a predetermined wake-up address that is different to each of the normal addresses of the external devices 20, 22, 24. The predetermined wake-up devices are arranged to respond to the predetermined wake-up addresses with the correct response (step 56) but also to change the address of the external device back from its predetermined wake-up address to the normal address.

In this way, any of the external devices can use the predetermined wake-up address and respond to that. In this way, a number of different devices can wake up the computer since any of these different devices can respond to the predetermined wake-up address. It is not necessary to poll each device separately.

A dongle according to the second embodiment was made and tested. The average current was 400 μA in sleep mode, within the specification.

Polling was carried out every second. Every second, an MLME poll was transmitted over air, i.e. a data request and an acknowledgement (ACK) waited for. Three retries are carried out, and the dongle waits in a receptive state for a total of 20 ms every second. The average current is less than 2.5 mA averaged over the cycle as required for a high power USB device.

Those skilled in the art will realise that many alternatives are also possible to these embodiment. The specific times that devices remain on may be varied depending on the application and the power requirements of the various components used.

The invention is not limited to the use of the ZigBee standard or 802.15.4 standards and other approaches are possible also.

The specific approach to powering up and powering down the interface and transceiver as set out above may be varied. In particular, standard chipsets may be used and the operation of such chipsets may be adopted.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method of operating a radio communications device connected to a computer to wirelessly communicate between the computer and at least one external device, wherein the computer has a suspend mode and an active mode and the radio communications device has a suspend mode and an active mode, the method comprising:
entering the suspend mode in the radio communications device from an active mode with the computer in the suspend mode;
periodically entering a polling mode in the radio communications device including transmitting a wireless signal to poll one or more external devices, waiting a predetermined period for a response signal, returning to the suspend mode if no wake-up response signal is received during the predetermined period, and if a wake-up response signal is received during the predetermined period returning the radio communications device to the active mode and communicating with the computer to cause the computer to return to the active mode.

2. A method according to claim 1 wherein the signals are IEEE 802.15.4 signals.

3. A method according to claim 2 including sending a data request as the wireless signal to poll one or more of the external devices and receiving data as the response signal from an active external device.

4. A method according to claim 3 wherein the data request is addressed to a predetermined wake-up address, the predetermined wake-up address being a common address for replying to by external devices with a wake-up response signal when the external devices are to wake up the radio communications device.

5. A method according to claim 2 including sending a beacon request as the wireless signal to poll one or more of the external devices and receiving a beacon frame as the response signal from an active external device.

6. A method according to claim 1 wherein the computer is connected to the radio communications device through a USB port, the method including powering the radio communications device through the USB port.

7. A method according to claim 1 wherein the radio communications device includes a transceiver, a timer and an interface, wherein the method includes:
in the step of entering the suspend mode in the radio communications device, powering down the interface and the transceiver;
in the polling mode the steps of:
powering up the transceiver before the step of transmitting a wireless signal to poll one or more external devices,
powering down the transceiver if no response signal is received during the predetermined period; and
powering up the interface if a response signal is received during the predetermined period before prompting the computer to cause the computer to return to the active mode.

8. A method according to claim 1 wherein the dongle draws less than 2.5 mA of power averaged over time over the suspend mode and periodic polling modes.

9. A method of operating a system including a computer with a dongle attached to the computer and at least one remote device having a wireless transceiver arranged to wirelessly communicate with the dongle, the method comprising:
in the dongle:
entering into a suspend mode;
periodically sending a polling signal to poll one or more of the remote devices;
waiting a predetermined period for a response; and
returning to an active mode if a wake-up response is received in the predetermined period;
and in the at least one remote device:
entering into a suspend mode in the remote device in which the transceiver in the remote device is off;
receiving user input in the remote device;
emerging from the suspend mode to the active mode on receiving the user input;
switching on the transceiver; and
waiting for a poll signal from the dongle before replying with a wake-up response to wake up the dongle.

10. A method according to claim 9 wherein at least one remote device is a mouse and the step of receiving user input is receiving a signal resulting from movement of the mouse.

11. A method according to claim 9 wherein at least one remote device is a keyboard and the step of receiving user input is receiving a keystroke entered on the keyboard.

12. A method according to claim 9 including sending a data request as the polling signal addressed to a predetermined wake-up address, wherein the at least one external device responds to the predetermined wake-up address with a wake-up response signal.

13. A method according to claim 12 wherein each external device has a different normal address and the predetermined wake-up address is a common address different to the normal address of any of the external devices, wherein each at least one external device only responds to the predetermined wake-up address when replying with a wake-up response signal to a poll signal and otherwise responds to its normal address.

14. A dongle for connecting to a computer for wirelessly linking the computer to one or more external devices, the dongle having an active mode and a suspend mode, the dongle comprising:
a radio transceiver;
a controller;
wherein the controller is adapted to cause the dongle to enter the suspend mode from the active mode and in the suspend mode periodically to enter into a poll mode in which the controller sends a signal to poll one or more of the external devices, to wait a predetermined period for a response, to return to the suspend mode if there is no correct response, and to return to an active mode if a response is received.

15. A dongle according to claim 14 wherein the dongle includes a housing and a USB connector for supporting the dongle by the USB connector when plugged into a USB port.

16. A dongle according to claim 14 wherein the signals are in accordance with the IEEE 802.15.4 standard.

17. A dongle according to claim 14 wherein the controller is adapted to send as the signal to poll one or more of the devices a data request signal addressed to a predetermine wake-up address.

18. A dongle according to claim 14, wherein the controller is adapted to send as the signal to poll one or more of the devices an active scan signal and to receive as the correct response a beacon frame.

19. A system including
a computer;
a radio communications device attached to the computer and powered by the computer having an active mode and a suspend mode;
at least one remote device having a wireless transceiver arranged to wirelessly communicate with the radio communications device, at least one of the at least one remote device or devices having an active mode in which the transceiver in the remote device is on and a suspend mode in which the transceiver in the remote device is off;
wherein in the suspend mode the radio communications device is arranged to periodically to enter into a poll mode in which the radio communications device sends a signal to poll one or more of the remote devices, to wait a predetermined period for a response, to return to the suspend mode if there is no correct response, and to return to an active mode if a response is received from one or more of the remote devices; and
the at least one remote device is arranged to emerge from the suspend mode to the active mode by user input and when emerging from the suspend mode to the active mode to switch on the wireless transceiver and to wait for a poll signal from the radio communications device before replying with a response signal.

20. A system according to claim 19 wherein one remote device is a mouse arranged to emerge from the suspend mode to the active mode when moved.

21. A system according to claim 19 wherein one remote device is a keyboard arranged to emerge from the suspend mode to the active mode when a key is depressed.

22. A system according to claim 19 wherein the signals are IEEE 802.15.4 signals.
